(19) United States
(12) Patent Application Publication
(10) Pub. No.: US 2012/0154173 A1
(43) Pub. Date: Jun. 21, 2012

(54) Wireless Signal Transceiver and Blind Spot Detection System

(76) Inventors: Tsai-Wang Chang, Hsinchu (TW); Cheng-Hsiung Hsu, Hsinchu (TW); Ta-Wei Hsu, Hsinchu (TW); Min-Jung Wu, Hsinchu (TW)

(21) Appl. No.: 13/013,821

(22) Filed: Jan. 26, 2011

(30) Foreign Application Priority Data
Dec. 15, 2010 (TW) 099143904

(51) Int. Cl. G08G 1/16; G01S 13/93

(52) U.S. Cl. 340/904; 342/70

(57) ABSTRACT

A wireless signal transceiver for a blind spot detection system includes a first substrate, a radio-frequency processing unit formed on the first substrate for transmitting a wireless signal and receiving a reflecting signal of the transmitted wireless signal, and a complex programmable logic device controlled by a digital signal processor for controlling operations of the radio-frequency processing unit according to at least a control command of the digital signal processor, so as to detect whether an object exists within a specific range.

### BACKGROUND OF THE INVENTION

1. Field of the Invention

The present invention relates to a wireless signal transceiver and blind spot detection system, more particularly, to a wireless signal transceiver and blind spot detection system, capable of reducing the manufacturing cost and the volume.

2. Description of the Prior Art

Statistics has shown most of traffic accidents relate to driver distraction when driving. If a driver receives a pre-alarm 0.5 seconds before a possible collision, at least 60% accidents of crashing into a front vehicle, 30% accidents of head-on crash, or 50% road-related accidents can be avoided. If the pre-alarm is received a second before the collision, 90% traffic accidents can be avoided. These statistical data illustrate that if the driver is provided with a response time, occurrence of the traffic accident can be efficiently reduced. A blind spot detection system is developed under this requirement to be an equipment of an intelligent vehicle.

The blind spot detection system is a vehicle safety technology achieving the pre-alarm by utilizing millimeter wave radar sensing technology, which detects obstacle conditions in blind spots of left and right sides or front side of the vehicle, by an image self-identification method of machine vision. If the system detects existence of a specific obstacle in the blind spot, a pre-alarm light or a sound signal is actively provided to the driver, such that the driver can determine a driving direction according to the alarm result, to avoid occurrence of the traffic accident caused by negligence or blind spot of the driver.

In general, in the blind spot detection system, a wireless signal transceiver is installed in a rear (and/or front) bumper of the vehicle, transmits a millimeter wave wireless signal and receives a reflecting signal of the transmitted wireless signal, to determine whether obstacles such as cars, humans, etc., are within a specific range. Since shock-absorbing Styrofoam or reinforcement bar is installed in the vehicle bumpers, available space is extremely limited. Thus, how to reduce the volume of the transceiver of the blind spot detection system becomes a goal of the industry.

Besides, considering the blind spot detection system can efficiently reduce incidence of traffic accidents, if the manufacturing cost of the blind spot detection system can be further reduced, vehicles equipping with the blind spot detection system can be efficiently increased, such that social costs caused by traffic accidents can be further reduced.

### SUMMARY OF THE INVENTION

It is therefore the main objective of the present invention to provide a wireless signal transceiver and blind spot detection system.

The present invention discloses a wireless signal transceiver for a blind spot detection system, including a first substrate, a radio-frequency processing unit formed on the first substrate for transmitting a wireless signal and receiving a reflecting signal of the transmitted wireless signal, and a complex programmable logic device controlled by a digital signal processor for controlling operations of the radio-frequency processing unit according to at least one control command of the digital signal processor, so as to detect whether an object exists within a specific range.

The present invention further discloses a blind spot detection system, including a plurality of alarms, each for generating an alarm signal, a control host, for respectively controlling each of the plurality of alarms to generate a corresponding alarm signal according to a plurality of signal processing results, a plurality of wireless signal transceivers, a first wireless signal transceiver of the plurality of wireless signal transceivers including a first substrate, a radio-frequency processing unit, formed on the first substrate, for transmitting a wireless signal and receiving a reflecting signal of the transmitted wireless signal, and a complex programmable logic device, for controlling operations of the radio-frequency processing unit according to at least one control command, so as to detect whether an object exists within a specific range, and a digital signal processor, for outputting the at least one control command to control operations of the first wireless signal transceiver, and generating a signal processing result of the plurality of signal processing results according to a detection result generated by the complex programmable logic device of the first wireless signal transceiver.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a schematic diagram of a blind spot detection system according to an embodiment of the present invention.

FIG. 1B is a functional block diagram of a wireless signal transceiver shown in FIG. 1A.

FIG. 1C is a schematic diagram of a structure of a wireless signal transceiver shown in FIG. 1A.

FIG. 2 is a functional block diagram of a wireless signal transceiver according to an embodiment of the present invention.

FIG. 3A is a functional block diagram of a wireless signal transceiver according to an embodiment of the present invention.

FIG. 3B is a schematic diagram of a structure of a wireless signal transceiver shown in FIG. 3A.

FIG. 4 is a schematic diagram of a blind spot detection system according to an embodiment of the present invention.

FIG. 5 is a schematic diagram of a blind spot detection system according to an embodiment of the present invention.

### DETAILED DESCRIPTION

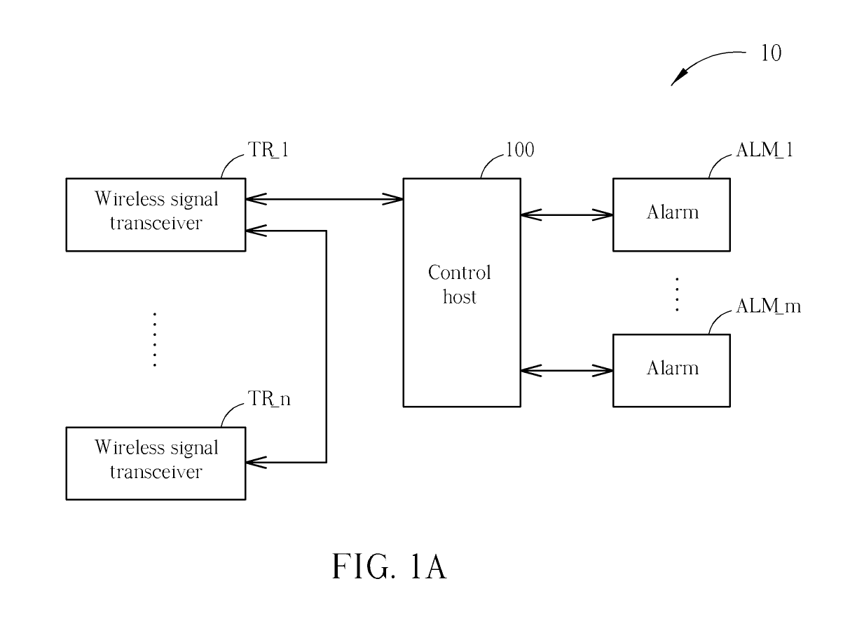

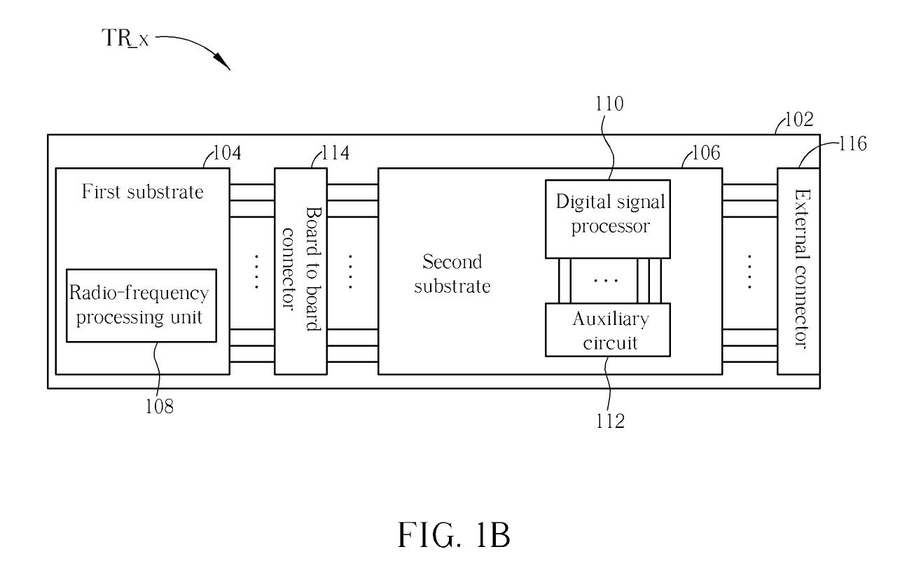

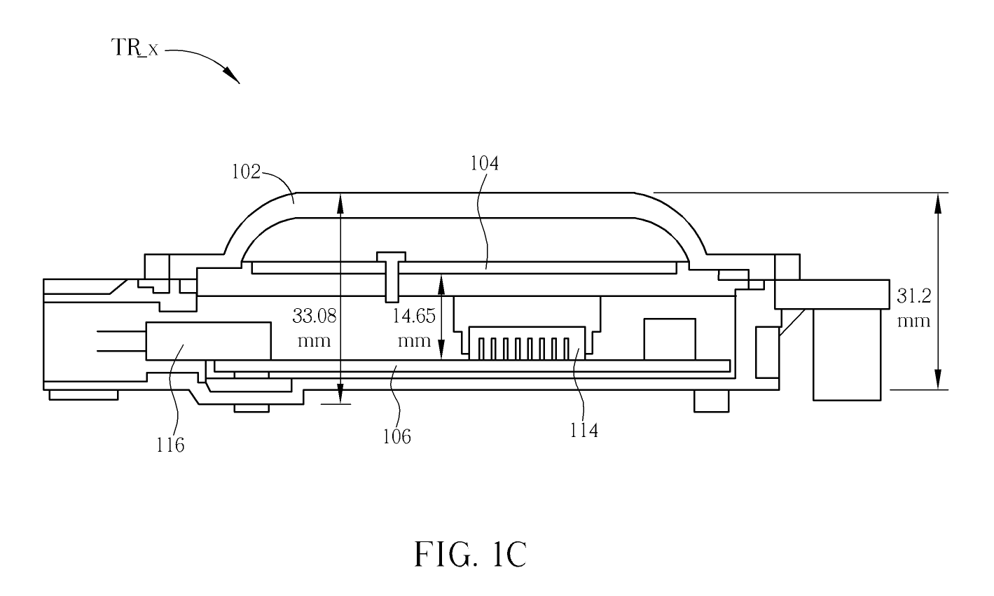

Please refer to FIG. 1A, which is a blind spot detection system 10 according to an embodiment of the present invention. The blind spot detection system 10 is installed in a vehicle, for detecting whether obstacles such as cars, humans, etc., are within specific blind spots, and outputting alarm signals accordingly, in order to avoid occurrence of a traffic accident caused by negligence or blind spot of a driver. The blind spot detection system 10 includes a control host 100, wireless signal transceivers TR_1-TR_n, and alarms ALM_1-ALM_m. The wireless signal transceivers TR_1-TR_n are installed in a rear (and/or front) bumper of the vehicle, and utilize radar sensing technology to detect whether obstacles exist in the blind spots of the driver. The wireless signal transceiver TR_1 is a primary wireless signal transceiver, which gathers data of the wireless signal transceivers TR_2-TR_n, and transmits the data to the control host 100. The control host 100 controls operations of the alarms ALM_1-ALM_m according to the data returned by the wireless signal transceiver TR_1. The alarms ALM_1-ALM_m can be devices capable of outputting pre-alarm light or sound signals, such as light emitting diodes, speakers, etc., so as to remind the driver whether a vehicle or a pedestrian approaches.

As shown in FIG. 1A, structures of the wireless signal transceivers TR_1-TR_n are identical. A difference is that the wireless signal transceiver TR_1 is set as the primary wireless signal transceiver for gathering data of the other wireless signal transceivers, while the rest are roughly the same. In detail, please continue to refer to FIG. 1B and FIG. 1C. FIG. 1B is a functional block diagram of an arbitrary wireless signal transceiver TR_x of the wireless signal transceivers TR_1-TR_n, and FIG. 1C is a schematic diagram of the wireless signal transceiver TR_x. As shown in FIG. 1B, the wireless signal transceiver TR_x includes a housing 102, a first substrate 104, a second substrate 106, a radio-frequency processing unit 108, a digital signal processor 110, an auxiliary circuit 112, a board to board connector 114, and an external connector 116. The radio-frequency processing unit 108 is formed on the first substrate 104, for processing radio frequency signals, i.e., transmitting a wireless signal and receiving a reflecting signal of the transmitted wireless signal. The digital signal processor 110 and the auxiliary circuit 112 are formed on the second substrate 106, for controlling operations of the radio-frequency processing unit 108 through the board to board connector 114, to determine whether an obstacle exists within the specific range according a receiving condition, so as to return data to the control host 100 through the external connector 116. The auxiliary circuit 112 can include auxiliary components such as a power system, memory, amplifier, etc., which is not an objective of the present invention and the detail is omitted.

In the wireless signal transceiver TR_x, the main reason that all components are respectively formed on the first substrate 104 and the second substrate 106 is that the first substrate 104 is the substrate for radio-frequency purpose, of which the manufacturing cost and the difficulty are higher than that of the second substrate 106. Thus, utilizing the substrates 104, 106 and the board to board connector 114 between them can efficiently reduce manufacturing difficulty and the cost. However, even though, in the wireless signal transceiver TR_x, the digital signal processor 110 still accounts for much manufacturing cost; especially when the amount of the wireless signal transceivers TR_1-TR_n increases, the increased cost becomes even more significant. Besides, since the two substrates 104, 106 and the board to board connector 114 need to be installed, thickness of the housing 102 cannot be efficiently reduced. Therefore, as shown in FIG. 1C, since thickness of the board to board connector 114 increases about 14.65 mm, thickness of the housing 102 reaches 31.2 mm (thickness of the thickest part of the housing 102 is 33.08 mm) accordingly. Thus, a great limitation is resulted to the limit space in the vehicle bumper.

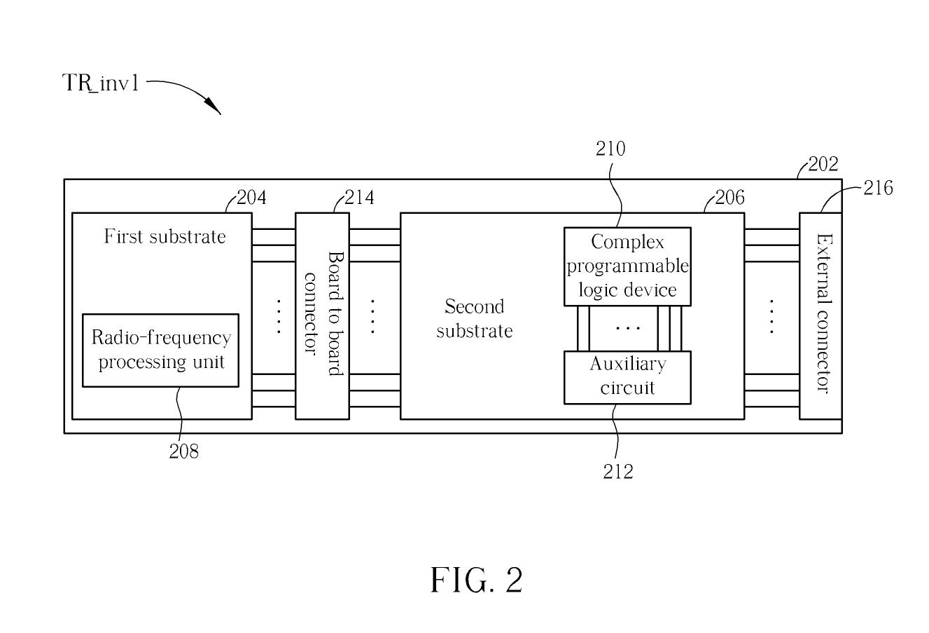

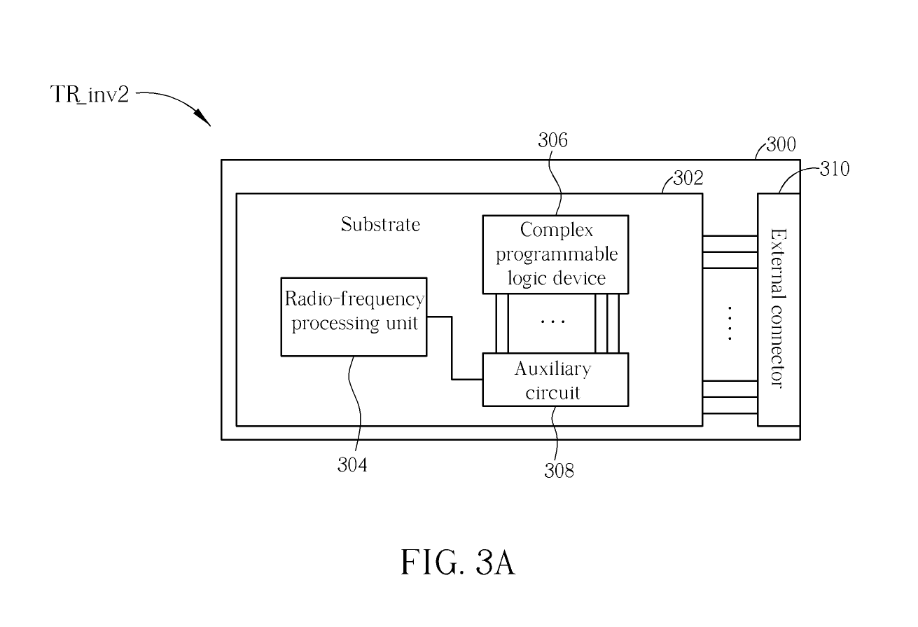

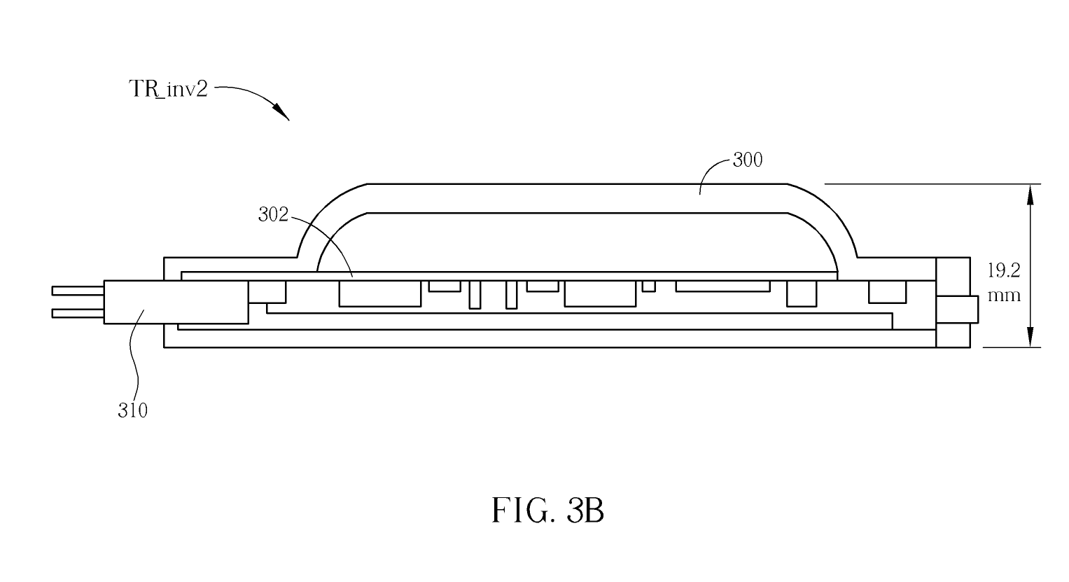

For improving disadvantages of the cost and the volume of the wireless signal transceivers TR_1-TR_n, the present invention further provides a wireless signal transceiver TR_inv1 and a wireless signal transceiver TR_inv2, shown in FIG. 2 and FIG. 3A, respectively. First, as shown in FIG. 2, the wireless signal transceiver TR_inv1 includes a housing 202, a first substrate 204, a second substrate 206, a radio-frequency processing unit 208, a complex programmable logic device (CPLD) 210, an auxiliary circuit 212, a board to board connector 214, and an external connector 216. As can be seen from comparing FIG. 2 and FIG. 1B, the wireless signal transceiver TR_inv1 does not include the digital signal processor 110 with high cost, but the complex programmable logic device 210 is used instead to process related signals. In such a situation, the auxiliary circuit 212 is also different from the auxiliary circuit 112. The auxiliary circuit 212 may further include a device such as an analog to digital converter, etc., to communicate with the radio-frequency processing unit 208.

As known by those skilled in the art, the complex programmable logic device is suitable for realizing any operation and combinational logic, which is equivalent to including a plurality of programmable array logics, and interconnected lines between each programmable array logic can also be planed, recorded, etc., in program. With such an all-in-one integration, the single complex programmable logic device can realize a circuit that originally be constructed by thousands, and even hundreds of thousands logic gates. In general, the manufacturing cost and required area of the complex programmable logic device 210 is much lower than that of the digital signal processor 110, and in different applications, the auxiliary circuit 112 may also include the complex programmable logic device. In such a situation, the manufacturing cost and the volume of the wireless signal transceiver TR_inv1 can be efficiently reduced. However, after removing the digital signal processor from the wireless signal transceiver TR_inv1, control of the radio-frequency processing unit 208 depends on an external digital signal processor or a microprocessor. Detailed implementations can be referred to the later description.

Furthermore, as shown in FIG. 3A, the wireless signal transceiver TR_inv2 includes a housing 300, a substrate 302, a radio-frequency processing unit 304, a complex programmable logic device 306, an auxiliary circuit 308, and an external connector 310. As can be seen from comparing FIG. 3A and FIG. 2, the wireless signal transceiver TR_inv2 merely includes the single substrate 302, and the board to board connector 214, which consumes too much space, is removed. In such a situation, as shown in FIG. 3B, thickness of the housing 300 is reduced to 19.2 mm. In other words, comparing with the transceiver TR_x shown in FIG. 1B, the wireless signal transceiver TR_inv2 not only reduces required manufacturing cost, but also reduces the volume.

In the wireless signal transceiver TR_inv2, the substrate 302 is for radio-frequency purpose. Although the substrate 302 requires higher cost, since required area of the wireless signal transceiver TR_inv2 is smaller, as a whole, the cost is reduced. More importantly, required volume of the wireless signal transceiver TR_inv2 is smaller, and this further facilitates practical applications.

On the other hand, as can be seen from the above, since the wireless signal transceiver TR_inv1 or the wireless signal transceiver TR_inv2 does not include the digital signal processor, control of the radio-frequency processing unit 208 or the radio-frequency processing unit 304 requires the external digital signal processor or the microprocessor. In such a situation, the present invention provides two structures, which are respectively detailed as follows.

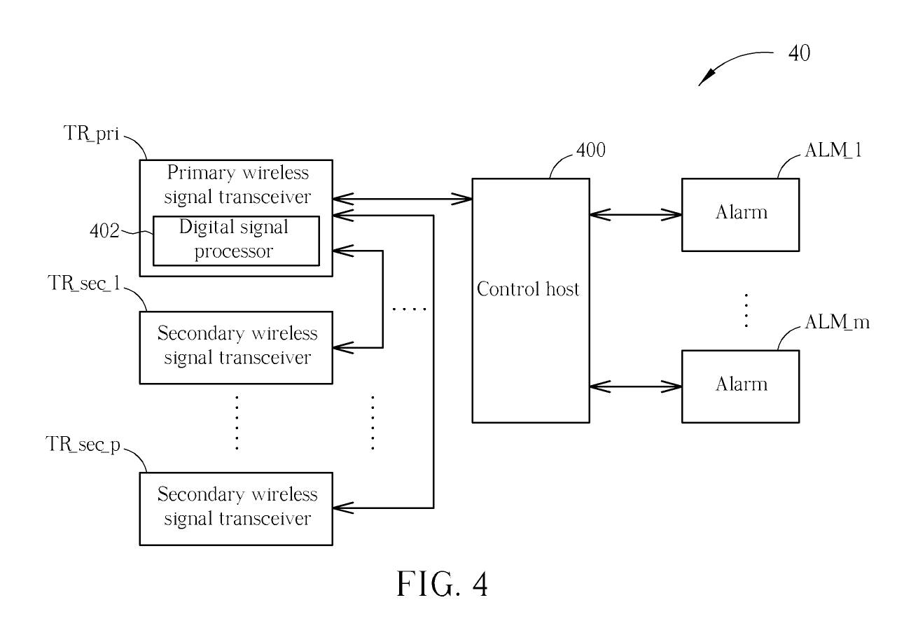

Please refer to FIG. 4, which is a schematic diagram of a blind spot detection system 40 according to an embodiment of the present invention. The blind spot detection system 40 is installed in a vehicle, for detecting whether obstacles such as cars, humans, etc., exist in specific blind spots, and outputs alarm signals accordingly to avoid occurrence of traffic accident caused by negligence or blind spot of a driver. The blind spot detection system 40 includes a control host 400, a primary wireless signal transceiver TR_pri, secondary wireless signal transceivers TR_sec_1-TR_sec_p, and alarms ALM_1-ALM_m. The primary wireless signal transceiver TR_pri and the secondary wireless signal transceivers TR_sec_1-TR_sec_p utilize radar sensing technology to detect whether obstacles exist in the blind spots of the driver. However, the difference is that the primary wireless signal transceiver TR_pri includes a digital signal processor 402, and the structure is the same as the wireless signal transceiver TR_x shown in FIG. 1B, for gathering data of the secondary wireless signal transceivers TR_sec_1-TR_sec_p, and transmitting the data to the host 400. The control host 400 control operations of the alarms ALM_1-ALM_m accordingly. And the secondary wireless signal transceivers TR_sec_1-TR_sec_p can be realized by the wireless signal transceiver TR_inv1 in FIG. 2 or the wireless signal transceiver TR_inv2 in FIG. 3A. The digital signal processor with high cost is not included, and the complex programmable logic device is used instead to process related signals.

Regarding implementation of the present invention, as the amount of the secondary wireless signal transceivers TR_sec_1-TR_sec_p increases, processing speed of the digital signal processor 402 must be considered. As to a design of more of the secondary wireless signal transceivers TR_sec_1-TR_sec_p, the digital signal processor 402 with higher processing speed can be adopted.

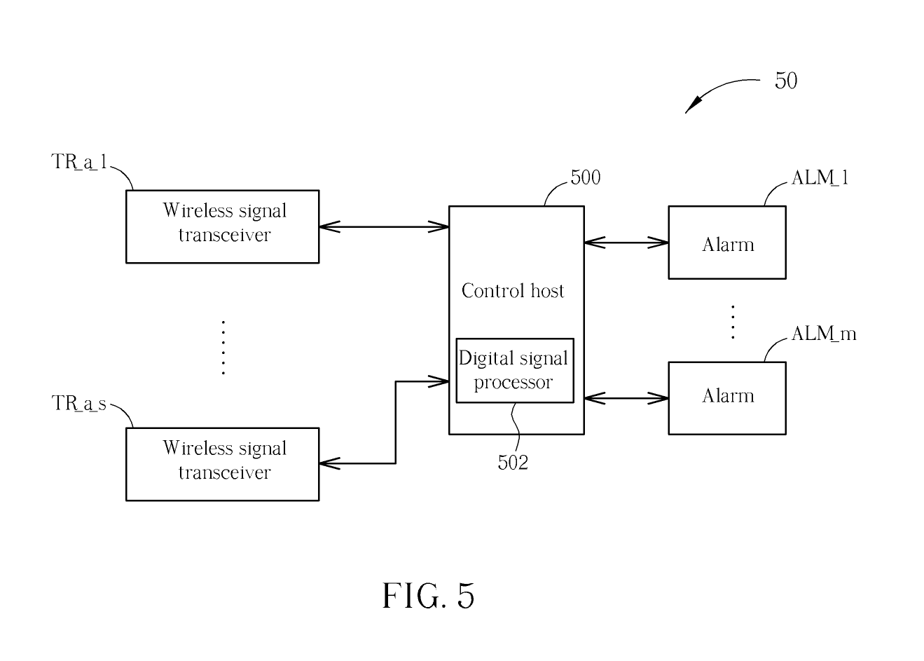

As to another structure, please refer to FIG. 5, which is a schematic diagram of a blind spot detection system 50 of an embodiment of the present invention. The blind spot detection system 50 includes a control host 500, wireless signal transceivers TR_a_1-TR_a_s, and alarms ALM_1-ALM_m. The wireless signal transceivers TR_a_1-TR_a_s utilize radar sensing technology, to detect whether obstacles exist in blind spots of a driver. The wireless signal transceivers TR_a_1-TR_a_s can be realized by the wireless signal transceiver TR_inv1 shown in FIG. 2 or the wireless signal transceiver TR_inv2 shown in FIG. 3A, i.e., the digital signal processor with high cost is not included, and the complex programmable logic device is used instead to process related signals. The wireless signal transceivers TR_a_1-TR_a_s are controlled by the digital signal processor 502 installed in the control host 500. In other words, the wireless signal transceivers TR_a_1-TR_a_s are not distinguished as the primary or the secondary, but the digital signal processor 502 performs data collection or transmission of control commands. Furthermore, the digital signal processor 502 can be integrated with the microprocessor in the control host 500 to further reduce the cost.

Regarding implementation of the present invention, as the amount of the wireless signal transceivers TR_a_1-TR_a_s increases, processing speed of the digital signal processor 502 installed in the control host 500 must be considered. Thus, as to a design of more of the wireless signal transceivers TR_a_1-TR_a_s, the digital signal processor 502 with higher processing speed can be adopted. Besides, links between the wireless signal transceivers TR_a_1-TR_a_s and the control host 500 should be capable of handling large amount of wireless data transmissions or receptions.

In the prior art, the available space in the vehicle bumper is extremely limited, which causes disadvantages to install the wireless signal transceivers of the blind spot detection system in the bumper. And, the wireless signal transceiver of the prior art blind spot detection system needs to include the digital signal processor; thus, the manufacturing cost cannot be efficiently reduced. In comparison, the present invention utilizes the complex programmable logic device for processing related signals of the wireless signal transceivers, and the digital signal processor is installed in one of the wireless signal transceivers or the control host. Thus, the manufacturing cost can be reduced, and the volume of the wireless signal transceiver can be efficiently reduced.

Noticeably, the spirit of the present invention is to reduce required volume and the manufacturing cost of the wireless signal transceiver of the blind spot detection system, variations are not limited to the above, and modifications and alterations can be made according to different requirements. For example, the amount of the wireless signal transceivers is not limited to any rule, as long as obstacles in the blind spots can be correctly detected. For example, for a mini passenger car, only blind spots at two rear sides of the car need to be detected; thus, the amount of the wireless signal transceivers can be 2. For a container truck, the blind spots may be at two sides of front, rear and even middle of the truck; thus, the amount of the wireless signal transceivers may be four to six, or even eight. However, any amount of the wireless signal transceivers is suitable for the concept of the present invention, and is not limited herein. Furthermore, the alarms ALM_1-ALM_m can be devices capable of outputting pre-alarm light or sound signals, and positions or the amount of the alarms ALM_1-ALM_m can be adjusted according to different applications. For example, if applied to the mini passenger car, two light emitting diodes installed at wing mirrors and an alarm speaker installed inside the car can realize the alarm. Besides, noticeably, schematic diagrams shown in FIG. 1C and FIG. 3B are exemplary embodiments. Practically, the structure, thickness, etc., of the wireless signal transceiver are related to design requirements, and are not limited herein.

To sum up, in the present invention, the wireless signal transceivers of the blind spot detection system do not need to install the digital signal processor with high cost, while the complex programmable logic device is used instead to process related signals. Therefore, the manufacturing cost is reduced, and the volumes of the wireless signal transceivers are further reduced.

Those skilled in the art will readily observe that numerous modifications and alterations of the device and method may be made while retaining the teachings of the invention.

What is claimed is:

1. A wireless signal transceiver, for a blind spot detection system, comprising:
a first substrate;
a radio-frequency processing unit, formed on the first substrate, for transmitting a wireless signal and receiving a reflecting signal of the transmitted wireless signal; and
a complex programmable logic device, controlled by a digital signal processor, for controlling operations of the radio-frequency processing unit according to at least one control command of the digital signal processor, so as to detect whether an object exists within a specific range.

2. The wireless signal transceiver of claim 1, further comprising:
a second substrate; and
a connector, for electrically connecting the first substrate and the second substrate;
wherein the complex programmable logic device is formed on the second substrate.

3. The wireless signal transceiver of claim 1, wherein the complex programmable logic device is formed on the first substrate.

4. The wireless signal transceiver of claim 1, wherein the digital signal processor is installed in another wireless signal transceiver of the blind spot detection system.

5. The wireless signal transceiver of claim 1, wherein the digital signal processor is installed in a control host of the blind spot detection system.

6. A blind spot detection system, comprising:
a plurality of alarms, each for generating an alarm signal;
a control host, for respectively controlling each of the plurality of alarms to generate a corresponding alarm signal according to a plurality of signal processing results;
a plurality of wireless signal transceivers, a first wireless signal transceiver of the plurality of wireless signal transceivers comprising:
a first substrate;
a radio-frequency processing unit, formed on the first substrate, for transmitting a wireless signal and receiving a reflecting signal of the transmitted wireless signal; and
a complex programmable logic device, for controlling operations of the radio-frequency processing unit according to at least one control command, so as to detect whether an object exists within a specific range; and
a digital signal processor, for outputting the at least one control command to control operations of the first wireless signal transceiver, and generating a signal processing result of the plurality of signal processing results according to a detection result generated by the complex programmable logic device of the first wireless signal transceiver.

7. The blind spot detection system of claim 6, wherein the first wireless signal transceiver further comprises:
a second substrate; and
a connector, for electrically connecting the first substrate and the second substrate;
wherein the complex programmable logic device is formed on the second substrate.

8. The blind spot detection system of claim 6, wherein the complex programmable logic device of the first wireless signal transceiver is formed on the first substrate.

9. The blind spot detection system of claim 6, wherein the digital signal processor is installed in another wireless signal transceiver different from the first wireless signal transceiver within the plurality of wireless signal transceivers.

10. The blind spot detection system of claim 6, wherein the digital signal processor is installed in the control host.
